(19) United States
(12) Patent Application Publication
(10) Pub. No.: US 2025/0102420 A1
(43) Pub. Date: Mar. 27, 2025

(54) APPARATUS AND METHOD FOR CORROSION PROTECTION MONITORING

(71) Applicant: Abriox Limited, Newport (GB)

(72) Inventor: Jason Hanlon, Bristol (GB)

(73) Assignee: Abriox Limited, Newport (GB)

(21) Appl. No.: 18/898,523

(22) Filed: Sep. 26, 2024

(30) Foreign Application Priority Data
Sep. 26, 2023 (GB) 2314725.9

(51) Int. Cl. G01N 17/02; C23F 13/04

(52) U.S. Cl. CPC G01N 17/02; C23F 13/04

(57) ABSTRACT

The present invention relates to apparatus for connection to a transformer rectifier unit which is operable to output an impressed cathodic protection current for cathodic protection of a metallic structure located below ground, the apparatus comprising:
a modulator unit in connection with the transformer rectifier unit and arranged for permanent electrical connection with a metallic structure, wherein when the apparatus is in use the modulator unit is operable to receive the impressed cathodic protection current from the transformer rectifier unit and to modulate the impressed cathodic protection current to produce a current mapping signal which is applied to the metallic structure, such that the current mapping signal flowing in the metallic structure can be detected and measured wirelessly from above ground, and wherein the current mapping signal is directly derived from, and corresponds to, the impressed cathodic protection current, and wherein the modulator unit is operable to be controlled remotely. The present invention further provides a method of surveying the impressed cathodic protection current in an underground metallic structure using the aforementioned apparatus.

The present invention relates to an apparatus for the generation of a current mapping signal for use in the assessment of corrosion protection. In particular, the present invention relates to an apparatus for use with metallic pipelines for the generation of a current mapping signal corresponding to the applied cathodic protection current that is controlled, and output, from a permanently installed remote monitoring unit.

### BACKGROUND OF THE INVENTION

Metallic structures, such as pipelines, cables and storage tanks which are buried underground are exposed to conditions which can promote corrosion of the structure. To try and minimise environmental damage to these structures, various methods of minimising corrosion have been developed. In particular, it is well known to use the technique of cathodic protection to reduce the occurrence of corrosion in such metallic structures.

To apply cathodic protection to a metallic structure, a protection system is used. An example of a pipeline 12 provided with a known protection system 10 is shown in FIG. 1 of the accompanying drawings. The protection system 10 of FIG. 1 is an impressed current cathodic protection (ICCP) system in which an anode 14, which is external to the structure 12, has an electrical connection with a transformer rectifier unit 16. The transformer rectifier unit 16 also has an electrical connection with the pipeline 12, and is operable to apply a DC voltage (and hence a DC current) across the anode and the structure, so that the structure is at a negative potential with respect to the anode 14. Corrosion of the structure is reduced by virtue of the fact that the anode 14, the transformer rectifier unit 16 and the structure 12 form an electrochemical cell. The DC current that flows through the ICCP system 10 serves to reduce or stop corrosive anodic reactions occurring on the surface of the pipeline 12. Such ICCP systems are well known.

Remote monitoring units (RMU) than monitor the operation of the ICCP system are also well known. They measure parameters such as output current and voltage and report the values to a central system using either wired connection methods, such as telephone lines or a computer network, or wireless connection methods such as radio, cellular modem or satellite communication. RMU's are often fitted with an interrupter device, relay or switch that enables the DC cathodic protection current being applied to the structure to be switched on and off. By switching the DC current on and off in a controlled manner an identifiable pattern of interruptions in the current flow will be generated. This is useful in a number of ways. For example, an Interrupter device could be set to apply a signal having a pattern of 1 second off and 4 seconds on. If a technician then directly connects a measurement device such as a voltmeter to a point on the pipeline and observes a change in potential consistent with this pattern then he knows that he is connected to the correct pipeline and also that the protection application system does have an influence at this location. The same measurement device can then be used to confirm the applied cathodic protection current is at an acceptable level to prevent corrosion. Electrochemical Potential measurements are taken with the current both on and off. These measurements are then repeated at other desired points along the pipe. This switching of the protective cathodic protection current is typically in the order of seconds off and seconds on in order for readings to be taken manually along the pipeline. The fastest cycle used is typically 0.2 seconds off and 0.8 seconds on and this requires a special measurement device connected to the pipeline to take the on and off readings.

The magnitude of the cathodic protection current flowing in a pipeline decreases as distance from the impressed current source increases. Determining the magnitude of the current flow along the pipeline is important to assess the area of influence of the impressed current source and the level of cathodic protection. The current intended to protect the pipeline along its length can enter the pipeline through defects in the pipeline coating (holidays) or by accidental, or intentional, electrical connections to other buried structures. This results in step changes in the current flow in the pipeline that in turn indicate areas of concern with respect to diminished cathodic protection and potential corrosion problems.

It is not possible from above ground to remotely or wirelessly measure the DC current flowing in the pipeline due to the earth's own magnetic fields and other sources of interference.

It is well known that to establish the location or route of a metallic underground pipeline a technique of applying an AC signal to the pipeline and then detecting the resultant electromagnetic signal using a conventional pipeline locator, operated by a user above-ground, can be used. The AC signal is usually applied to the structure using a portable transmitter temporarily connected to a portion of the pipeline either directly, or by induction, at a known pipeline location. The AC signal is usually greater than 90 Hz in order to be detectable with conventional antennas. The AC signal is useful for locating the pipeline but it is not representative of the DC cathodic protection current due to the impedance of the pipeline and soil. The flow of AC and DC currents are different in pipelines and soil.

In order to reduce direct connections to the pipeline a hybrid method has been developed to survey the DC current flow in the pipeline where an extremely low frequency electromagnetic (pipeline current mapping) signal is generated and applied to the pipeline that is low enough in frequency to adequately represent DC cathodic protection current. This pipeline current mapping signal is applied using a portable high-power transmitter. This signal is such that it can be measured from above ground using magnetometers (rather than antennas which could not detect this frequency) thus reducing the number of direct connections required to take readings along the pipeline.

The known method has many limitations:

A large high-power portable transmitter is required.

The transmitter, despite being high powered, only has a limited range on a pipeline and needs to be moved to multiple locations in order to survey a pipeline. The portable transmitter doesn't have the same range as the original impressed current cathodic protection current source.

The transmitter needs to be set up and connected to the pipeline before readings can be taken.

The transmitter has no remote control.

The transmitted signal is artificial and not linked to the actual cathodic protection current applied to the pipeline.

The RMU and current interrupter are not utilised.

Therefore, there is a need for an improved apparatus and method of operation that allows the accurate assessment of corrosion protection along longer lengths of a pipeline, under applied cathodic protection, in a more efficient manner and with a signal more representative of the applied cathodic protection current.

### SUMMARY OF THE INVENTION

The present invention seeks to address the problems of the prior art. It integrates the capability of the pipeline current mapping transmitter into an RMU and it uses the applied cathodic protection current as a source rather than generate a simulated signal.

Aspects of the present invention are set out in the attached claims.

According to a first aspect of the present invention, there is provided an apparatus for connection to a transformer rectifier unit which is operable to output an impressed cathodic protection current for cathodic protection of a metallic structure located below ground, the apparatus comprising: a modulator unit with remote communication and arranged for permanent electrical connection with a metallic structure, wherein when the apparatus is in use the modulator unit is operable to receive the impressed cathodic protection current from the transformer rectifier unit and to modulate the impressed cathodic protection current to produce a current mapping signal which is applied to the metallic structure, such that the current mapping signal flowing in the metallic structure can be detected and measured wirelessly from above ground, and wherein the current mapping signal is directly derived from, and corresponds to, the impressed cathodic protection current, and wherein the modulator unit is operable to be controlled remotely.

A second aspect of the present invention provides an apparatus for use in measuring the cathodic protection of a metallic structure located below ground, the apparatus comprising: a transformer rectifier unit which is operable to output an impressed cathodic protection current for cathodic protection of a metallic structure located below ground; and a modulator unit with remote communication arranged for permanent connection to the metallic structure, wherein when the apparatus is in use the modulator unit is operable to receive the impressed cathodic protection current from the transformer rectifier unit and modulate the received impressed cathodic protection current to produce a current mapping signal which is applied to the metallic structure, such that the current mapping signal flowing in the metallic structure can be detected and measured wirelessly from above ground, and wherein the current mapping signal is directly derived from, and corresponds to, the impressed cathodic protection current, and wherein the modulator unit is operable to be controlled remotely.

In one embodiment, the transformer rectifier unit is also operable to be controlled remotely.

In a further embodiment, the apparatus further comprises a remote monitor unit for monitoring the transformer rectifier unit and/or the modulator unit.

Preferably, the current mapping signal has a modulation frequency of between 1 Hz and 12 Hz. More preferably, the current mapping signal has a modulation frequency of between 3 Hz and 8 Hz.

In one embodiment, the modulator unit is integral with the transformer rectifier unit.

The current mapping signal will be detectable above ground using a current mapping device.

In a further embodiment, the modulator unit is also operable to generate a locatable AC signal from the transformer rectifier unit.

Preferably, the locatable signal has a modulation frequency of above 90 Hz.

A third aspect of the present invention provides a method of surveying the impressed cathodic protection current in an underground metallic structure, the method comprising the steps of:
(i) connecting:
   a transformer rectifier unit and an apparatus in accordance with a first aspect of the present invention: or
   an apparatus in accordance with a second aspect of the present invention,
   to an underground buried metallic structure:
(ii) operating the transformer rectified unit to supply an impressed cathodic protection current to provide cathodic protection for the structure:
(iii) operating the modulator unit of the apparatus to modulate the impressed cathodic protection current being supplied to the metallic structure to provide a current mapping signal to the metallic structure; and
(iv) wirelessly detecting and measuring the current mapping signal above ground.

In one embodiment, the current mapping signal is wirelessly detected and measured above ground using a wireless current measurement device to generate a current map. Preferably, the current mapping device is operable to save the current mapping signal data and/or transmit the current mapping data wirelessly or via wired means to a control centre or monitoring station.

In one embodiment, the method further comprises the step of analysing the current map data to assess the cathodic protection applied across the metallic structure.

In a further embodiment, the method further comprises an intermediate step between step (i) and step (ii) of operating the modulator unit of the apparatus to generate a locatable higher frequency AC output from the transformer rectifier unit for detection by a receiving device above ground to locate the position of the underground metallic structure where the AC signal is usually greater than 90 Hz in order to be detectable with conventional antennas.

Preferably, the locatable higher frequency AC output is generated by modulation of a DC current output from the transformer rectifier unit.

In one embodiment, a portable locator transmitter is in electrical communication with the pipeline and wherein the locatable higher frequency AC output is generated by the portable locator transmitter.

It is to be appreciated that the metallic structure may comprise any metallic structure, such as, but not limited to, metal cables, a metal storage tank or similar, but is preferably a pipeline or network of pipelines.

### BRIEF DESCRIPTION OF THE DRAWINGS

FIG. 1 illustrates a pipeline provided with a known protection application system;

FIG. 2 illustrates a pipeline provided with first embodiment of apparatus in accordance with the present invention;

FIG. 3 illustrates a pipeline provided with a second embodiment of apparatus accordance with the present invention;

FIG. 4 illustrates a pipeline provided with a modulated current by the apparatus of FIG. 2; and

FIG. 5 illustrates a technician taking a wireless current measurement on a pipeline provided with a modulated current by the apparatus of FIG. 2.

FIG. 6 illustrates a technician taking a wireless current measurement on the pipeline provided with a modulated current by the apparatus of FIG. 2 together with an additional locate signal transmitter.

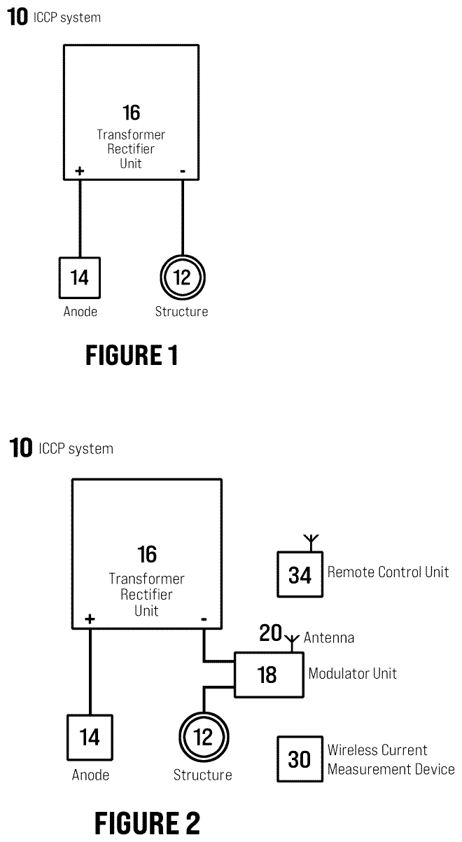

### DETAILED DESCRIPTION OF THE PREFERRED EMBODIMENTS

The following description relates to an embodiment of an apparatus in accordance with the present invention in connection with a metallic pipeline. However, it is to be appreciated that the present invention can be used with any metallic structure including, but not limited to, pipelines, cables, storage tanks and the like.

FIG. 2 shows an ICCP system 10, in electrical connection with a metallic pipeline 12. The ICCP system 10 comprises an anode 14 which, in the illustration shown, is a groundbed i.e. an electrode array installed beneath the ground to provide a low resistance electrical path to ground or earth. The ICCP system 10 is further provided with a transformer rectifier unit 16 and a modulator unit 18, which in the illustration shown, is a monitor modulator unit provided with a wireless antenna 20 and operable to receive incoming control signals and to transmit outgoing data signals to a control centre or monitoring station.

The transformer rectifier unit 16 is electrically connected to the anode 14, the modulator unit 18 which in turn has an electrical connection to the structure/pipeline 12. The transformer rectifier unit 16 is operable to output a DC current. The modulator unit 18 is connected to receive the DC current output from the transformer rectifier unit 16 and can transmit this current, as an impressed cathodic protection current, directly to the pipeline 12 without modulation.

However, upon a receipt of an appropriate command generated by a remote control unit 34 and received by wireless antenna 20, the modulator unit 18 is operable to modulate the DC current output from the transformer rectifier and produce a low frequency composite output current which is applied to the structure/pipeline 12. The modulated current, when applied to the pipeline 12, results in an electromagnetic field that is radiated by the pipeline, and can be locally wirelessly measured by a pipeline current mapping device 30. The remote control unit 34 is, in this case a wireless device such as a mobile phone.

The modulation of the DC current within modulator unit 18 may be performed using electronic means. However, it will be appreciated that any suitable modulating system may be implemented including, but not limited to a solid state relay, mercury relay or an electromechanical relay.

The modulator unit 18 modulates the output of the transformer rectifier 16 to generate a modulated current i.e. a current mapping signal, that flows along pipeline 12 (See FIG. 4).

When modulated current 40 flows in the pipeline 12, an electromagnetic field 42 is created which emanates from pipeline 12. Despite the pipeline 12 being buried in ground 13, the electromagnetic field 42 can be measured by wireless mapping device 30. Typically, the modulated signal will include a frequency of 3 Hz or 4 Hz but this could be any suitable frequency from 1 Hz upwards. Preferably, a frequency as low as possible in order to approximate the cathodic protection DC current and that is also wirelessly measurable is selected.

The map of wirelessly measured cathodic protection DC current is critical to ensure the current is flowing on the desired pipeline and not on other pipelines or buried metal structures that may have become in electrical connection with the protected pipeline. The ability to measure the current wirelessly allows a measurement to be taken at any point and a complete map to be generated.

The modulator unit 18 can also act upon the DC current output from the transformer rectifier unit 16 to cause the DC current to be interrupted. In this case, an interrupted DC signal will be applied to the pipeline 12 enabling assessment of the level of cathodic protection being applied, the pinpointing of coating defects, faults, and identification of specific structures.

The interruption of the DC current allows direct measurement at electrical connection points along the pipeline. In this case the electrical potential of the pipeline is measured with both the DC current on and off. The levels read can be assessed to determine the level of cathodic protection being received by the pipeline at these points. The electrical test points are distributed along the length of a pipe typically miles apart.

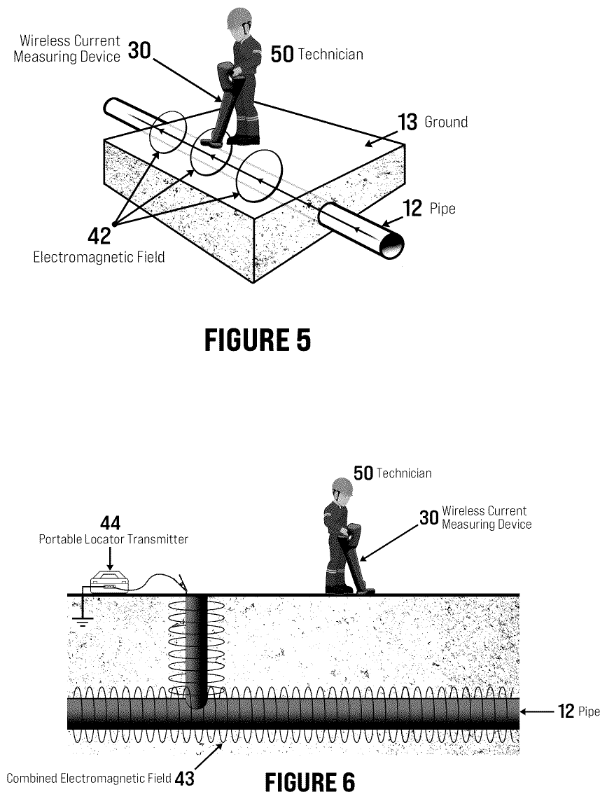

In use, the control of the modulator unit 18 is implemented by the remote control unit 34, thus the signal modulation can be implemented remotely. The remote control unit 34 is able to determine if the modulator unit 18 is modulating the signal from the transformer rectifier unit 16 before application to the pipeline 12 or if the signal from the transformer rectifier unit 16 is being applied without modulation to the pipeline 12. The remote control unit 34 can further determine (and control) which frequencies of output signal the modulating unit 18 is generating. The remote control unit 34 can also generate command signals which cause the modulating unit 18 to switch the modulating function on or off. Upon remote control unit 34 generating a control signal which determines the modulation function be switched on, the modulator unit 18 will receive the command to modulate the output received from the transformer rectifier unit 16 and generate a modulated current i.e. current mapping signal 40 to be applied to pipeline 12. Thus, as can be seen in FIG. 5, a technician 50 in the field can then use the wireless current measurement device 30 to map the current flowing in the pipeline 12.

The desired values are that of the current mapping signal, which in turn directly relates to the DC cathodic protection current. The wireless measurement device analyses the electromagnetic field emanating from the pipeline to calculate the magnitude of the current mapping signal. The electromagnetic field will contain both the frequencies of the current mapping signal and the locate signal. Both signals are required because to calculate the magnitude of the current mapping signal first the position and depth of the pipeline must be determined (using the locate signal).

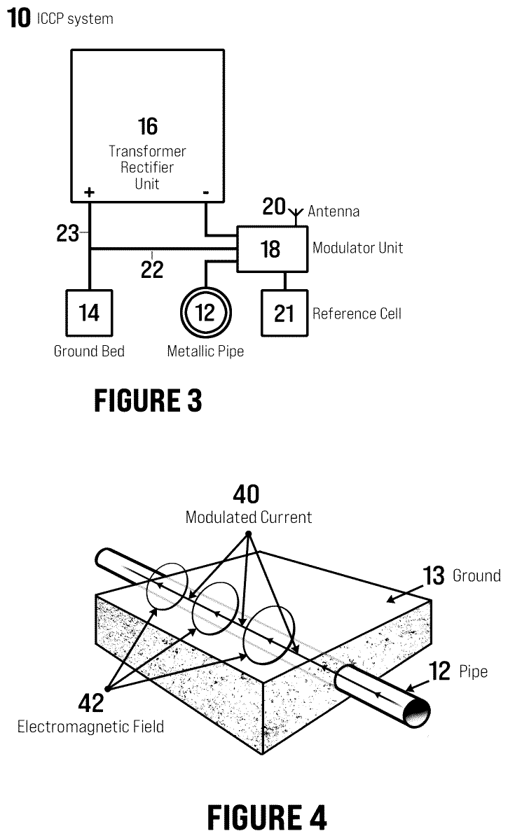

In FIG. 3 there is shown a second embodiment, which in this case is ICCP system 10, connected to a metallic pipeline 12. The apparatus 10 comprises an anode 14, in this case a groundbed, a transformer rectifier unit 16, a modulator unit 18 provided with a wireless antenna 20 and a reference cell unit 21. The reference cell unit input to modulator unit 18 allows the modulator unit 18 to monitor the cathodic protection level being applied to the metallic structure by the transformer rectifier unit 16. The anode 14 is in electrical connection with the transformer rectifier unit 16 which in turn is in electrical connection with the modulator unit 18. Modulator unit 18 is also in electrical connection with the pipeline 12 and reference cell 21.

Modulator unit 18 is further connected, via connection 22, to the connection 23 between the transformer rectifier unit 16 and anode 14. In this embodiment, the connection 22 which connects the modulator unit 18 to connection 23 enables the modulator unit 18 to monitor the output voltage of the transformer rectifier unit 16. By monitoring the output voltage of transformer rectifier unit 16, the modulator unit 18 is able to determine whether the transformer rectifier unit 16 is functional and set at an appropriate level. Internally, the modulator unit 18 may monitor the current flow to the pipeline 12 from the transformer rectifier unit 16 to ensure that cathodic protection current is being applied and that the level is correct to provide cathodic protection to pipeline 12.

Thus, as well the providing cathodic protection to pipeline 12 as shown in FIG. 2, the ICCP system 10 can be arranged as shown in FIG. 3 to monitor other parameters including, but not limited to the AC supply to the transformer rectifier, the cathodic protection potential of the pipeline and other transformer rectifier outputs. Alternatively, the modulator unit 18 can be connected so that fewer parameters are be monitored, or no parameters may be monitored.

Further, the modulator unit 18 when in electrical connection with the transformer rectifier unit 16 can directly modulate the source of the impressed cathodic protection current and provide a pipeline current mapping signal to pipeline 12 that directly corresponds to the applied cathodic protection. The reach of the current mapping signal along the pipeline 12 is the same as that of the cathodic protection current, as the source of the signal is the transformer rectifier. By contrast, the reach of a signal applied by a conventional portable transmitter generating an artificial current mapping signal is significantly less. Thus, a longer section of pipeline 12 can be surveyed using the apparatus and method of the present application.

FIG. 6 illustrates the situation where, in order to perform a wireless pipeline current survey utilising an extremely low frequency, it may also be necessary to simultaneously provide an electromagnetic signal on the same pipeline at a higher frequency 43 in order to locate the pipeline 12, and to determine the pipeline depth. The modulator unit 18 (see FIG. 3) of the present invention could provide this higher frequency or it may be applied independently using a portable locator transmitter 44. The higher frequency will not travel as far along the pipeline as the cathodic protection current due the capacitive effects of the pipeline coating. However, by using the modulator unit 18 to provide the current mapping signal together with a portable locator transmitter 44, the locating signal can be applied to the pipeline at convenient points along the pipeline route. This allows the locating signal to be provided along the entire length of the pipeline that is protected by the impressed cathodic protection current whilst the pipeline current map generated is contiguous and the current mapping signal applied from a single source location. This allows a current mapping survey to be carried out efficiently along the full length of pipeline being provided with cathodic protection by transformer rectifier unit 16. Further, where accurate pipeline location data is already available, the current mapping survey can be provided along the full length of pipeline being provided with cathodic protection by transformer rectifier unit 16, without the need for portable locator transmitters to provide location signals.

Although aspects of the invention have been described with reference to the embodiment shown in the accompanying drawings, it is to be understood that the invention is not limited to the precise embodiment shown and that various changes and modifications may be effected without further inventive skill and effort, for example, whilst the embodiments above have been described in relation to detecting a pipeline 12, the ICCP system 10 incorporating the application of the present invention may be used with any metallic structure including, but not limited to pipelines, cables, support struts, containers and the like. In addition, the modulation of the DC signal within remote monitor modulator 18 is described in the above embodiments as being implemented within a separate component 18 at the output of the transformer rectifier unit 16. However, the remote monitor modulator 18 may be connected to the transformer rectifier unit 16 such that the signal modulation occurs at an internal intermediate stage within the transformer rectifier unit 16. Alternatively, the remote monitor modulator 18 may apply a control signal to the transformer rectifier 16 so that it modulates its own output in accordance with the control signal. Alternatively, the function of the remote monitor modulator 18 may be incorporated partially or entirely into the transformer rectifier unit.

In addition, in the above embodiments, the modulated signal 40 may be a sine wave or a square wave, or any suitable waveform which contains the frequency components that can be used for mapping the pipeline current flow.

Furthermore, in the above embodiments the remote control unit 34 which generates a remote command to the modulator unit 18 has been described as a mobile phone. However, it will be appreciated that the remote control unit 34 may be any wireless electronic system such as a laptop or notebook. Alternatively the remote control unit 34 could utilise any suitable satellite communication system, internet connection or any other suitable wireless means. It will also be appreciated that the remote command could be issued by a remote control unit 34 located remotely from the technician, such as from an office managing the technician's workload, and so enable the technician, who is in the field, to take the required measurements or conduct a survey.

Furthermore, it is possible for the connection to the metallic pipe 12 to be a connection to multiple pipelines so that multiple pipelines can be accommodated without the need for multiple modulator units.

The embodiments of the invention have been described with reference to protection and location of a buried metallic pipeline for the sake of consistency, clarity, and simplicity. However, it will be readily appreciated that the techniques described are applicable to any metallic structure, such as a pipeline, storage tank or foundation that requires, or would benefit from, cathodic protection from corrosion.

What is claimed is:

1. An apparatus for connection to a transformer rectifier unit which is operable to output an impressed cathodic protection current for cathodic protection of a metallic structure located below ground, the apparatus comprising:
a modulator unit in electrical connection with the transformer rectifier unit and arranged for permanent electrical connection with a metallic structure, wherein when the apparatus is in use the modulator unit is operable to receive the impressed cathodic protection current from the transformer rectifier unit and to modulate the impressed cathodic protection current to produce a current mapping signal which is applied to the metallic structure, such that the current mapping signal flowing in the metallic structure can be detected and measured wirelessly from above ground, and wherein the current mapping signal is directly derived from, and corresponds to, the impressed cathodic protection current, and wherein the modulator unit is operable to be controlled remotely.

2. The apparatus for use in measuring the cathodic protection of a metallic structure located below ground, the apparatus comprising:
a transformer rectifier unit which is operable to output an impressed cathodic protection current for cathodic protection of a metallic structure located below ground; and
an apparatus as claimed in claim 1 for connection to the transformer rectifier unit and operable to output an impressed cathodic protection current for protection of a metallic structure located below ground.

3. The apparatus as claimed in claim 1, wherein the transformer rectifier unit is operable to be controlled remotely.

4. The apparatus as claimed in claim 1, further comprising a remote monitor unit for monitoring the transformer rectifier unit and/or the modulator unit.

5. The apparatus as claimed in claim 1, wherein the current mapping signal has a modulation frequency of between 1 Hz and 12 Hz

6. The apparatus as claimed in claim 5, wherein the current mapping signal has a modulation frequency of between 3 Hz and 8 Hz.

7. The apparatus as claimed in claim 2, wherein the modulator unit is integral with the transformer rectifier unit.

8. The apparatus as claimed in claim 1, wherein the current mapping signal is detectable above ground using a current mapping device.

9. The apparatus as claimed in claim 8, wherein the current mapping device is operable to transmit current mapping signal data wirelessly or via wired means to a control centre or monitoring station.

10. The apparatus as claimed in claim 1, wherein the modulator unit is further operable to generate a locatable AC output from the transformer rectifier unit.

11. A method of surveying the impressed cathodic protection current in an underground metallic structure, the method comprising the steps of:
(i) connecting a transformer rectifier unit and an apparatus as claimed in claim 1 to an underground buried metallic structure:
(ii) operating the transformer rectified unit to supply a impressed cathodic protection current to provide cathodic protection for the structure:
(iii) operating the modulator unit of the apparatus to modulate the impressed cathodic protection current being supplied to the metallic structure to provide a current mapping signal to the metallic structure; and
(iv) wirelessly detecting and measuring the current mapping signal above ground.

12. The method of surveying the impressed cathodic protection current in an underground metallic structure, the method comprising the steps of:
(i) connecting an apparatus as claimed in claim 2 to an underground buried metallic structure:
(ii) operating the transformer rectified unit to supply a impressed cathodic protection current to provide cathodic protection for the structure:
(iii) operating the modulator unit of the apparatus to modulate the impressed cathodic protection current being supplied to the metallic structure to provide a current mapping signal to the metallic structure; and
(iv) wirelessly detecting and measuring the current mapping signal above ground.

13. The method of claim 11, wherein the current mapping signal is wirelessly detected and measured above ground using a current mapping device to generate current map data.

14. The method of claim 13, wherein the current mapping device is operable to save the current mapping data and/or transmit the current mapping data wirelessly or via wired means to a control centre or monitoring station.

15. The method of claim 13 further comprising the step of analysing the current mapping signal data to assess the cathodic protection applied across the metallic structure.

16. The method of claim 11, further comprising an intermediate step between step (i) and step (ii) of operating the modulator unit of the apparatus to generate a locatable higher frequency AC output from the transformer rectifier unit for detection by a receiving device above ground to locate the position of the underground metallic structure.

17. The method of claim 16, wherein the locatable higher frequency AC output is above 90 Hz.

18. The method of claim 16, wherein the locatable higher frequency AC output is generated by modulation of a DC current output from the transformer rectified unit.

19. The method of claim 16, wherein a portable locator transmitter is in electrical connection with the metallic structure and the locatable higher frequency AC output is generated by the portable locator transmitter either instead of or in addition to the modulator unit.

20. The apparatus of claim 1, wherein the metallic structure comprises a pipeline.

21. The method of claim 11, wherein the metallic structure comprises a pipeline.
